(19) United States
(12) Patent Application Publication
(10) Pub. No.: US 2025/0308778 A1
(43) Pub. Date: Oct. 2, 2025

(54) MULTILAYER CERAMIC ELECTRONIC COMPONENT

(71) Applicant: TAIYO YUDEN CO., LTD., Tokyo (JP)

(72) Inventor: Maiko YAMANE, Tokyo (JP)

(21) Appl. No.: 19/078,763

(22) Filed: Mar. 13, 2025

(30) Foreign Application Priority Data
Mar. 28, 2024 (JP) 2024-053107
Dec. 17, 2024 (JP) 2024-221132

(51) Int. Cl. H01G 4/012; H01G 4/01; H01G 4/12

(52) U.S. Cl. CPC H01G 4/012; H01G 4/129; H01G 4/01

(57) ABSTRACT

A multilayer ceramic electronic component includes a laminate including a plurality of ceramic layers laminated in a direction of a first axis, a plurality of internal electrodes one of which is located between each pair of adjacent ceramic layers of the plurality of ceramic layers, and a pair of side surfaces that are perpendicular to a second axis orthogonal to the first axis and at which ends of the plurality of internal electrodes in a direction of the second axis are located; and a pair of side margins covering the pair of side surfaces. At least at a part of boundaries between the laminate and the pair of side margins, an Si concentration discontinuously increases from the laminate to the pair of side margins.

### CROSS-REFERENCE TO RELATED APPLICATIONS

This patent application is based on and claims priority to Japanese Patent Application No. 2024-053107 filed on Mar. 28, 2024 and Japanese Patent Application No. 2024-221132 filed on Dec. 17, 2024, the entire contents of which are incorporated herein by reference.

### TECHNICAL FIELD

The present disclosure relates to a multilayer ceramic electronic component.

### BACKGROUND

A technique of attaching side margins at a later step in the manufacturing process of multilayer ceramic capacitors is known (see, for example, Patent Document 1). This technique is advantageous for miniaturizing multilayer ceramic capacitors and increasing the capacitance of multilayer ceramic capacitors because both side ends of a plurality of internal electrodes can be reliably covered even by thin side margins.

As an example, in the multilayer ceramic capacitor manufacturing method described in Patent Document 1, a multilayer sheet of laminated ceramic sheets having printed internal electrodes is cut, thereby producing a plurality of laminates having side surfaces that are the cut surfaces where the internal electrodes are exposed. Then, side margins are formed at both the side surfaces of the laminates by punching out the ceramic sheets at the side surfaces of the laminates.

### RELATED ART DOCUMENT

### Patent Document

Patent Document 1: Japanese Laid-open Patent Application Publication No. 2012-209539

### SUMMARY

According to one aspect of the present disclosure, a multilayer ceramic electronic component includes: a laminate including a plurality of ceramic layers laminated in a direction of a first axis, a plurality of internal electrodes one of which is located between each pair of adjacent ceramic layers of the plurality of ceramic layers, and a pair of side surfaces that are perpendicular to a second axis orthogonal to the first axis and at which ends of the plurality of internal electrodes in a direction of the second axis are located; and a pair of side margins covering the pair of side surfaces. At least at a part of boundaries between the laminate and the pair of side margins, an Si concentration discontinuously increases from the laminate to the pair of side margins.

According to another aspect of the present disclosure, a multilayer ceramic electronic component includes a laminate including a plurality of ceramic layers laminated in a direction of a first axis, a plurality of internal electrodes one of which is located between each pair of adjacent ceramic layers of the plurality of ceramic layers, and a pair of side surfaces that are perpendicular to a second axis orthogonal to the first axis and at which ends of the plurality of internal electrodes in a direction of the second axis are located. The laminate includes: a capacitance formation portion including the plurality of internal electrodes, and a plurality of inter-electrode ceramic layers of the plurality of ceramic layers, one of the plurality of inter-electrode ceramic layers being located between each pair of adjacent internal electrodes of the plurality of internal electrodes; and a pair of covers including outermost ceramic layers of the plurality of ceramic layers, the pair of covers sandwiching the capacitance formation portion. At boundaries between the capacitance formation portion and the pair of covers, an Si concentration discontinuously increases from the capacitance formation portion to the pair of covers.

### BRIEF DESCRIPTION OF THE DRAWINGS

FIG. 1 is a perspective diagram illustrating a multilayer ceramic capacitor according to a first embodiment;

FIG. 2 is a first cross-sectional diagram illustrating the multilayer ceramic capacitor according to the first embodiment;

FIG. 3 is a second cross-sectional diagram illustrating the multilayer ceramic capacitor according to the first embodiment;

FIG. 4 is a diagram illustrating an Si concentration distribution near a boundary between a capacitance formation portion and a side margin in the first embodiment;

FIG. 5 is a diagram illustrating an Si concentration distribution near a boundary between a cover and the side margin in the first embodiment;

FIG. 6 is a flowchart illustrating a method of manufacturing the multilayer ceramic capacitor according to the first embodiment;

FIG. 7 is a perspective diagram illustrating an unfired laminate provided in step S01 of the above manufacturing method;

FIG. 8 is a perspective diagram illustrating an unfired ceramic body obtained in step S02 of the above manufacturing method;

FIG. 9 is a partial cross-sectional diagram schematically illustrating a microstructure of the side margin in the first embodiment;

FIG. 10 is a diagram illustrating an Si concentration distribution near a boundary between a capacitance formation portion and a side margin in comparative examples;

FIG. 11 is a diagram illustrating an Si concentration distribution near a boundary between a cover and the side margin in the comparative examples;

FIG. 12 is a partial cross-sectional diagram schematically illustrating a microstructure of the side margin in the comparative examples;

FIG. 13 is a partial cross-sectional diagram schematically illustrating a distribution state of glass particles in the side margin of the first embodiment;

FIG. 14 is a diagram schematically illustrating the distribution state of the glass particles in the side margin of the first embodiment;

FIG. 15 is a cross-sectional diagram illustrating internal electrodes that are partially oxidized;

FIG. 16 is a diagram illustrating an Si concentration distribution near a boundary between a capacitance formation portion and a side margin in a second embodiment;

FIG. 17 is a diagram illustrating an Si concentration distribution near a boundary between a cover and the side margin in the second embodiment;

FIG. 18 is a diagram illustrating an Si concentration distribution near a boundary between a capacitance formation portion and a cover in a third embodiment;

FIG. 19 is a diagram illustrating an Si concentration distribution near a boundary between the cover and a side margin in the third embodiment;

FIG. 20 is a diagram illustrating an Si concentration distribution near a boundary between the capacitance formation portion and the side margin in the third embodiment;

FIG. 21 is a diagram illustrating an Si concentration distribution near a boundary between a capacitance formation portion and a cover in a fourth embodiment;

FIG. 22 is a diagram illustrating an Si concentration distribution near a boundary between the cover and a side margin in the fourth embodiment;

FIG. 23 is a diagram illustrating an Si concentration distribution near a boundary between the capacitance formation portion and the side margin in the fourth embodiment;

FIG. 24 is a diagram illustrating an Si concentration distribution near a boundary between a capacitance formation portion and a cover in a fifth embodiment;

FIG. 25 is a diagram illustrating an Si concentration distribution near a boundary between the cover and a side margin in the fifth embodiment; and

FIG. 26 is a diagram illustrating an Si concentration distribution near a boundary between the capacitance formation portion and the side margin in the fifth embodiment.

### DETAILED DESCRIPTION

The multilayer ceramic capacitor having thin side margins in the related art may have a lowered moisture resistance.

According to the present disclosure, it is possible to increase moisture resistance.

In the following, embodiments of the present disclosure will be described in detail, but the present disclosure is not limited to these. Here, in the present specification and the drawings, components having substantially the same functional configurations are denoted by the same reference symbols, and duplicated description thereof may be omitted. In addition, in some of the drawings, an X axis, a Y axis, and a Z axis orthogonal to each other are appropriately illustrated. The X axis, the Y axis, and the Z axis define a fixed coordinate system fixed with respect to a multilayer ceramic capacitor.

### First Embodiment

First, a first embodiment will be described. The first embodiment relates to a multilayer ceramic capacitor.

### [Structure of Multilayer Ceramic Capacitor]

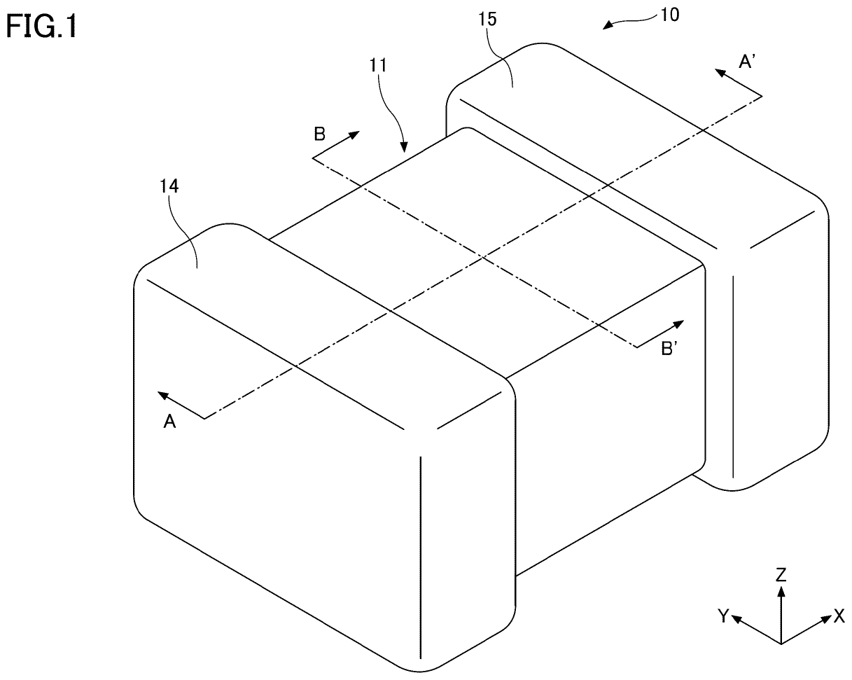

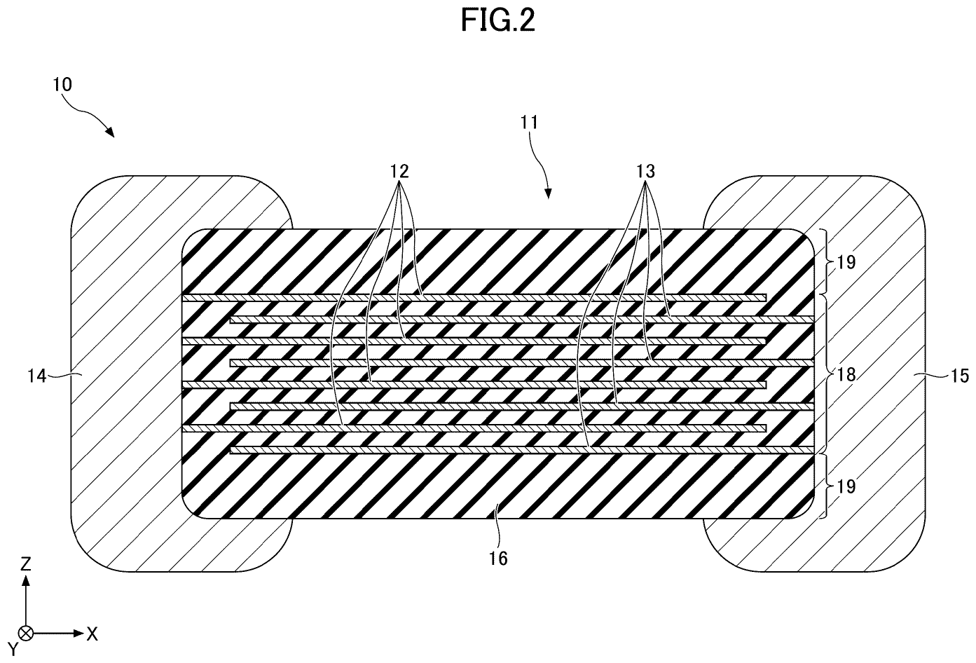

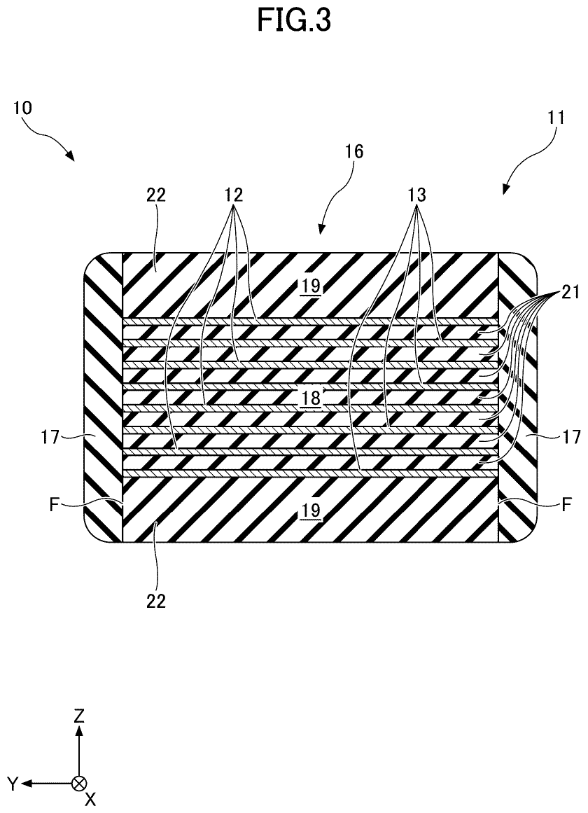

FIG. 1 is a perspective diagram illustrating a multilayer ceramic capacitor according to the first embodiment. FIGS. 2 and 3 are cross-sectional diagrams illustrating the multilayer ceramic capacitor according to the first embodiment. FIG. 2 is a cross-sectional diagram taken along the line A-A′ in FIG. 1. FIG. 3 is a cross-sectional diagram taken along the line B-B′ in FIG. 1.

A multilayer ceramic capacitor 10 according to the first embodiment includes a ceramic body 11, a first external electrode 14, and a second external electrode 15. The ceramic body 11 is formed in a hexahedron shape having a pair of end surfaces orthogonal to the X axis, a pair of side surfaces orthogonal to the Y axis, and a pair of main surfaces orthogonal to the Z axis. The first external electrode 14 and the second external electrode 15 cover the pair of end surfaces of the ceramic body 11.

The pair of end surfaces, the pair of side surfaces, and the pair of main surfaces of the ceramic body 11 are all flat surfaces. The flat surface in the present embodiment is not required to be strictly flat as long as it is recognized as flat when viewed as a whole, and includes, for example, a surface having a minute uneven shape of the surface, a gently curved shape present in a predetermined range, and the like.

The first external electrode 14 and the second external electrode 15 face each other in the X-axis direction with the ceramic body 11 being sandwiched between the first external electrode 14 and the second external electrode 15. The first external electrode 14 and the second external electrode 15 respectively extend from the end surfaces of the ceramic body 11 beyond the main surfaces and the side surfaces. With this, in the first external electrode 14 and the second external electrode 15, both of a cross section parallel to an X-Z plane and a cross section parallel to an X-Y plane have a U shape.

Here, the shapes of the first external electrode 14 and the second external electrode 15 are not limited to those illustrated in FIG. 1. For example, the first external electrode 14 and the second external electrode 15 may respectively extend from both the end surfaces of the ceramic body 11 beyond only one main surface, and the cross section parallel to the X-Z plane may have an L shape. In addition, the first external electrode 14 and the second external electrode 15 are not required to extend beyond any of the main surfaces and the side surfaces.

The first external electrode 14 and the second external electrode 15 are formed of a good conductor of electricity. Examples of the good conductor of electricity forming the first external electrode 14 and the second external electrode 15 include a metal or an alloy containing copper (Cu), nickel (Ni), tin (Sn), palladium (Pd), platinum (Pt), silver (Ag), gold (Au), and the like, as a main component. Here, in the present embodiment, the main component refers to a component having the highest content ratio.

The ceramic body 11 includes a laminate 16 and a pair of side margins 17. The laminate 16 forms the pair of main surfaces and the pair of end surfaces of the ceramic body 11 and has a pair of side surfaces F that are perpendicular to the Y axis. The pair of side margins 17 respectively cover the pair of side surfaces F of the laminate 16, and form a pair of side surfaces of the ceramic body 11.

The laminate 16 has a configuration in which a plurality of ceramic layers having a flat plate shape and extending along the X-Y plane are laminated in the Z-axis direction. The laminate 16 includes a capacitance formation portion 18 and a pair of covers 19. The pair of covers 19 cover the capacitance formation portion 18 from above and below in the Z-axis direction, and form a pair of main surfaces of the ceramic body 11. The plurality of ceramic layers include a plurality of inter-electrode ceramic layers 21 included in the capacitance formation portion 18 and a pair of outermost ceramic layers 22 included in the pair of covers 19. The capacitance formation portion 18 is sandwiched between the pair of outermost ceramic layers 22 in the Z-axis direction.

The capacitance formation portion 18 includes a plurality of first internal electrodes 12 and a plurality of second internal electrodes 13. The first internal electrode 12 and the second internal electrode 13 are formed in a sheet shape and extend along the X-Y plane. The first internal electrodes 12 and the second internal electrodes 13 are arranged between the plurality of ceramic layers. The first internal electrodes 12 and the second internal electrodes 13 are alternately arranged along the Z-axis direction. That is, in the capacitance formation portion 18, the first internal electrode 12 and the second internal electrode 13 face each other in the Z-axis direction with the ceramic layer being sandwiched between the first internal electrode 12 and the second internal electrode 13.

The first internal electrodes 12 are drawn out to the end surface covered by the first external electrode 14. The second internal electrodes 13 are drawn out to the end surface covered by the second external electrode 15. With this, the first internal electrode 12 is connected only to the first external electrode 14, and the second internal electrode 13 is connected only to the second external electrode 15.

The first internal electrode 12 and the second internal electrode 13 are formed over the overall width of the capacitance formation portion 18 in the Y-axis direction, and both ends of the first internal electrode 12 and the second internal electrode 13 in the Y-axis direction are located on both the side surfaces F of the laminate 16. With this, in the ceramic body 11, the positions of the ends of the first internal electrodes 12 and the second internal electrodes 13 in the Y-axis direction fall within a range of 0.5 micrometers (μm) in the Y-axis direction on both the side surfaces F of the laminate 16.

The first internal electrode 12 and the second internal electrode 13 are formed of a good conductor of electricity. Typical examples of the good conductor of electricity forming the first internal electrode 12 and the second internal electrode 13 include nickel (Ni) or an alloy containing nickel as a main component. Further examples include a metal or an alloy containing copper (Cu), palladium (Pd), platinum (Pt), silver (Ag), gold (Au), and the like, as a main component.

With such a configuration, in the multilayer ceramic capacitor 10, when a voltage is applied between the first external electrode 14 and the second external electrode 15, the voltage is applied to the plurality of inter-electrode ceramic layers 21 between the first internal electrodes 12 and the second internal electrodes 13. With this, in the multilayer ceramic capacitor 10, electric charges corresponding to the voltage between the first external electrode 14 and the second external electrode 15 are stored.

In the ceramic body 11 of the multilayer ceramic capacitor 10, the plurality of ceramic layers (inter-electrode ceramic layers 21) forming the capacitance formation portion 18, the pair of covers 19, and the pair of side margins 17 each include a polycrystalline substance of a dielectric ceramic material as a main component.

In the ceramic body 11, a dielectric ceramic material having a high dielectric constant is used to increase the capacitance of the ceramic layers of the capacitance formation portion 18. Examples of the dielectric ceramic having a high dielectric constant include a material having a perovskite structure containing barium (Ba) and titanium (Ti), which is represented by barium titanate (BaTiO₃).

Here, the ceramic layers may be formed of a compositional system, such as strontium titanate (SrTiO₃), calcium titanate (CaTiO₃), magnesium titanate (MgTiO₃), calcium zirconate (CaZrO₃), calcium zirconate titanate (Ca(Zr,Ti)O₃), barium zirconate (BaZrO₃), titanium dioxide (TiO₂), or the like.

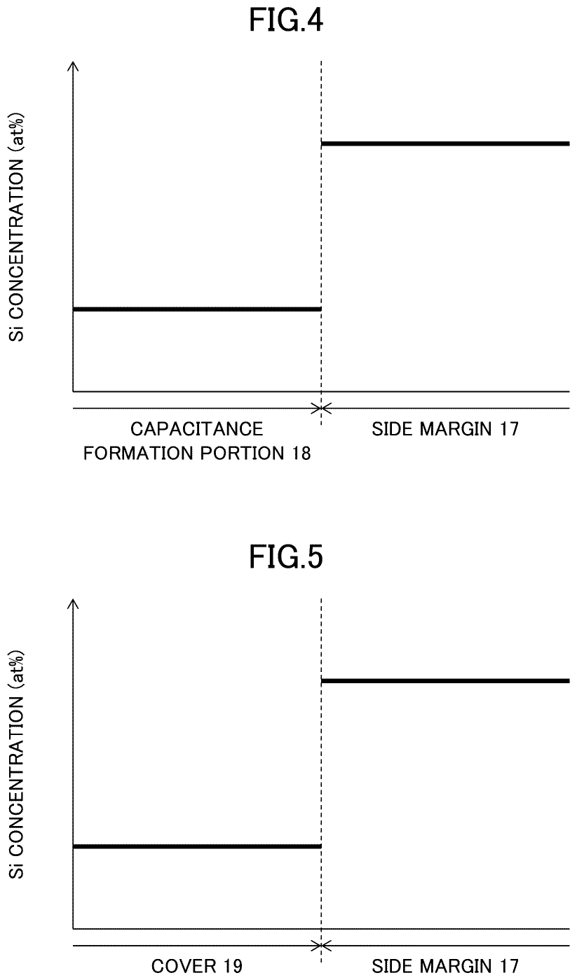

In the present embodiment, the Si concentration discontinuously increases from the laminate 16 to the pair of side margins 17 at the boundaries between the laminate 16 and the pair of side margins 17. FIG. 4 is a diagram illustrating an Si concentration distribution near the boundary between the capacitance formation portion 18 and the side margin 17 in the first embodiment. FIG. 5 is a diagram illustrating an Si concentration distribution near the boundary between the cover 19 and the side margin 17 in the first embodiment.

Although details will be described below, in the present embodiment, an organosilicon compound is used as a sintering aid for the formation of the side margins 17, and Si is contained in the side margins 17. The side margins 17 may contain glass particles that contain Si as a main component. On the other hand, no organosilicon compound is used for the formation of the inter-electrode ceramic layers 21 included in the capacitance formation portion 18 and the outermost ceramic layers 22 included in the covers 19, and the Si concentration in the inter-electrode ceramic layers 21 and the outermost ceramic layers 22 is lower than the Si concentration in the side margins 17. The inter-electrode ceramic layers 21 and the outermost ceramic layers 22 may be substantially free of Si. As illustrated in FIG. 4, at the boundary between the capacitance formation portion 18 and the pair of side margins 17, the Si concentration discontinuously increases from the capacitance formation portion 18 to the pair of side margins 17. Also, as illustrated in FIG. 5, at the boundaries between the covers 19 and the pair of side margins 17, the Si concentration discontinuously increases from the covers 19 to the pair of side margins 17. At the boundaries between the capacitance formation portion 18 and the pair of side margins 17, the difference in the Si concentration is preferably 4 atomic percent (at %) or more, and more preferably 5 at % or more. At the boundaries between the covers 19 and the pair of side margins 17, the difference in the Si concentration may be 4 at % or more or may be 5 at % or more. In the present disclosure, when the Si concentration is measured in a first 3-μm region from the boundary toward the side margin 17 and a second 3-μm region from the boundary toward the cover 19 or the capacitance formation portion 18, if the difference in the Si concentration between the first 3-μm region and the second 3-μm region is 4 at % or more, this corresponds to “the Si concentration discontinuously increases”.

The Si concentration ratio between the capacitance formation portion 18 and the side margin 17 is from 6 to 9 in the side margin 17 with the Si concentration in the capacitance formation portion 18 being 1. Also, the Si concentration ratio between the cover 19 and the side margin 17 is from 2 to 6 in the side margin 17, with the Si concentration in the cover 19 being 1.

### [Method of Manufacturing Multilayer Ceramic Capacitor]

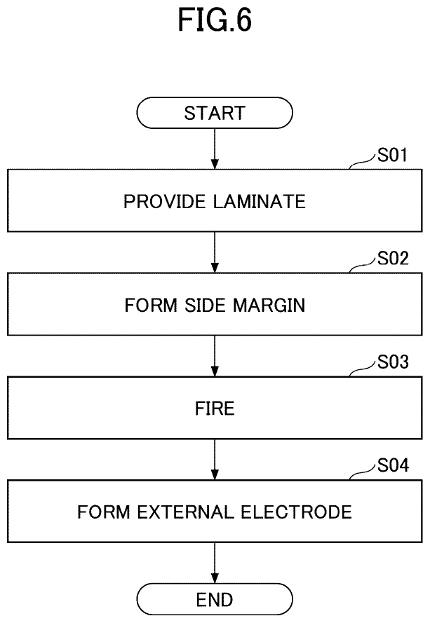

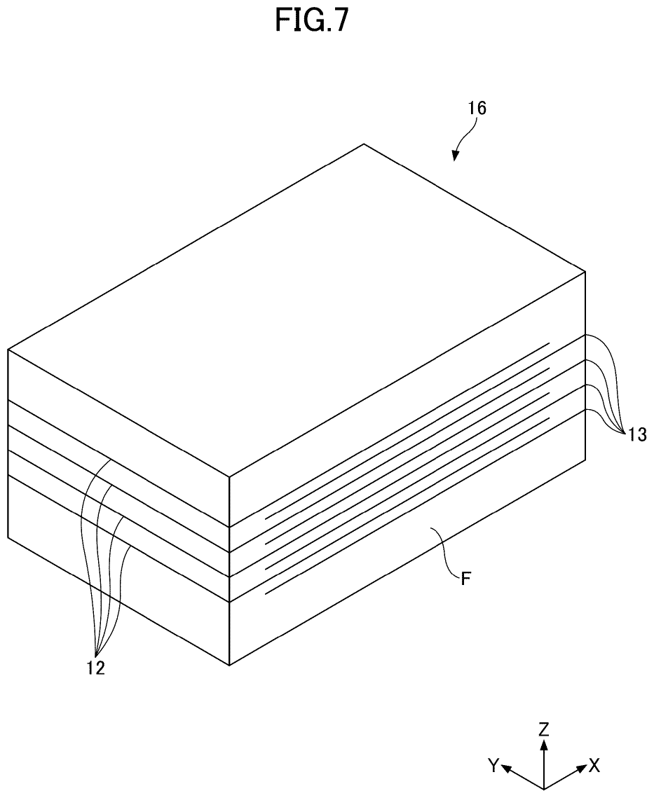

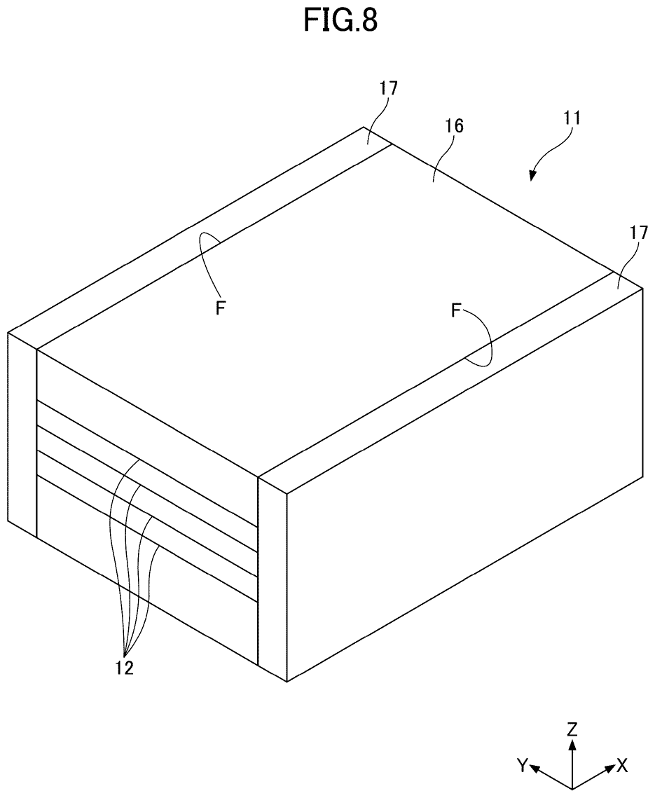

Next, a method of manufacturing the multilayer ceramic capacitor 10 will be described. FIG. 6 is a flowchart illustrating the method of manufacturing the multilayer ceramic capacitor 10 according to the first embodiment. FIGS. 7 and 8 are diagrams illustrating manufacturing steps of the multilayer ceramic capacitor 10. In the following, the method of manufacturing the multilayer ceramic capacitor 10 will be described with reference to FIG. 6 and, if necessary, with reference to FIGS. 7 and 8.

### (Step S01: Provision of Laminate)

In step S01, an unfired laminate 16 illustrated in FIG. 7 is provided. The unfired laminate 16 can be produced using a multilayer sheet in which a plurality of large-sized ceramic sheets are laminated in the Z-axis direction. The ceramic sheets corresponding to the capacitance formation portion 18 are patterned with a conductive paste for forming the first internal electrodes 12 and the second internal electrodes 13.

The unfired laminate 16 is obtained by cutting and dividing the above multilayer sheet along the X-Z plane and a Y-Z plane. For cutting the multilayer sheet, for example, a cutting device equipped with a press-cutting blade, a rotary blade, or the like can be used. With this, in the laminate 16, the pair of side surfaces F are obtained as cut surfaces at which ends of the first internal electrodes 12 and the second internal electrodes 13, respectively, in the Y-axis direction are located.

### (Step S02: Formation of Side Margins)

In step S02, the pair of unfired side margins 17 is provided on the pair of side surfaces F of the unfired laminate 16 produced in step S01. With this, as illustrated in FIG. 8, the unfired ceramic body 11 having a pair of side surfaces formed by the unfired side margins 17 is obtained.

For the unfired side margins 17, a ceramic slurry containing an organosilicon compound as a sintering aid is used. As the organosilicon compound, a silicone resin, a silicon oligomer, or the like can be used. The ceramic slurry can be prepared in the following manner. First, a dispersion liquid in which an organosilicon compound and a binder are mixed together is provided. As the binder, polyvinyl butyral (PVB) can be used. Next, a slurry of a dielectric ceramic material forming the side margins 17, such as barium titanate or the like, and the dispersion liquid are dispersed and then emulsified. In this manner, a ceramic slurry for the side margins 17 in which the organosilicon compound is uniformly dispersed can be produced.

The side margins 17 can be formed by a desired method. The side margins 17 can be formed using, for example, ceramic sheets obtained by forming the ceramic slurry in a sheet shape. In this case, for example, the ceramic sheets can be punched out at the side surfaces F of the laminate 16 or cut in advance, thereby attaching the ceramic sheets to the side surfaces F of the laminate 16.

Also, for forming the side margins 17, an unformed ceramic slurry can be used as it is, rather than a ceramic sheet formed in a sheet shape in advance. In this case, for example, the ceramic slurry can be applied to the side surfaces F of the laminate 16 by dipping the side surfaces F of the laminate 16 in the ceramic slurry.

### (Step S03: Firing)

In step S03, the ceramic body 11 obtained in step S02 is fired, thereby producing the ceramic body 11 of the multilayer ceramic capacitor 10 illustrated in FIGS. 1 to 3.

### (Step S04: Formation of External Electrodes)

In step S04, the first external electrode 14 and the second external electrode 15 are formed at respective ends, in the X-axis direction, of the ceramic body 11 fired in step S03, thereby forming the multilayer ceramic capacitor 10 illustrated in FIGS. 1 to 3. A method of forming the first external electrode 14 and the second external electrode 15 in step S04 can be selected as desired from publicly known methods. The first external electrode 14 and the second external electrode 15 may be formed in the ceramic body and then fired at the same time.

Through the above-described process, the multilayer ceramic capacitor 10 illustrated in FIGS. 1 to 3 is completed. According to this manufacturing method, the side margins 17 are formed at the side surfaces F of the laminate 16 in which the first internal electrodes 12 and the second internal electrodes 13 are exposed. Thus, the positions of the ends, in the Y-axis direction, of the first internal electrodes 12 and the second internal electrodes 13 in the ceramic body 11 fall within a range of 0.5 μm in the Y-axis direction.

In the multilayer ceramic capacitor 10 according to the first embodiment, an organosilicon compound is used as a sintering aid for the side margins 17. Thus, the side margins 17 are highly densified, and excellent moisture resistance can be obtained. Therefore, even if the side margins 17 are thin, entry of moisture from the exterior into the side margins 17 can be suppressed, and oxidation of the first internal electrodes 12 and the second internal electrodes 13 can be suppressed.

Also, excellent moisture resistance is obtained especially near the interface between the cover 19 and the side margin 17. With this, even if a slight extent of delamination occurs between the cover 19 and the side margin 17, oxidation of the first internal electrodes 12 and the second internal electrodes 13 can be suppressed.

Note that for increasing densification, SiO₂ may be used as a sintering aid for the side margins. However, when SiO₂ is used, Si ions are diffused from the side margins into the laminate during firing due to the difference in the Si concentration between the laminate and the side margins. As a result, the crystal particle size of the inter-electrode ceramic layers is changed from a designed value, and electric characteristics, such as a capacitance and the like, cannot be obtained as designed.

On the other hand, when an organosilicon compound is used, Si ions derived from the organosilicon compound are combined, during firing, with constituent elements of a dielectric ceramic material, such as, for example, barium of barium titanate, thereby forming glass particles, such as BaSi glass and the like. In terms of reaction energy and the like, this reaction preferentially occurs to formation of SiO₂ and diffusion of Si ions into the laminate 16. Therefore, in the present embodiment, diffusion of Si ions from the side margins 17 into the laminate 16 is prevented. As a result, the Si concentration discontinuously increases from the capacitance formation portion 18 to the pair of side margins 17 at the boundaries between the capacitance formation portion 18 and the pair of side margins 17. Also, the Si concentration discontinuously increases from the covers 19 to the pair of side margins 17 at the boundaries between the covers 19 and the pair of side margins 17. This suppresses change from a designed value of the crystal particle size of the inter-electrode ceramic layers 21 caused by diffusion of Si ions, and electric characteristics, such as a capacitance and the like, can be obtained as designed.

The size of glass particles depends on the size of siloxane bonds in the organosilicon compound, and is likely to be equal to or larger than the size of crystal particles of a ceramic material, such as barium titanate or the like. Therefore, diffusion of Si contained in glass particles beyond the grain boundaries of the crystal particles of the ceramic material is unlikely to occur, and diffusion of Si into the laminate 16 is suppressed.

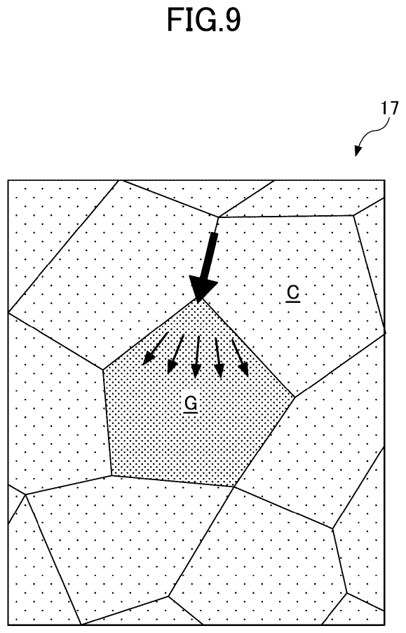

FIG. 9 is a partial cross-sectional diagram schematically illustrating a microstructure of the side margin 17. In FIG. 9, a plurality of crystal particles C forming the polycrystalline substance are illustrated with a rough dot pattern, and a glass particle G is illustrated with a dense dot pattern. The side margin 17 has a characteristic microstructure in which the glass particle G has a size equal to or larger than the size of the crystal particles C.

FIG. 9 illustrates a state in which a crack formed in the side margin 17 is about to grow in a direction indicated by the thick arrow. In a growing path of the crack illustrated in FIG. 9, the glass particle G exists. Therefore, in the state illustrated in FIG. 9, energy to be a driving force for growth of cracks is applied to the glass particle G.

The glass particle G, which is highly viscous, has the effect of absorbing energy applied from the crack. Especially, the glass particle G is large in the side margin 17, and thus the energy applied from the crack can be sufficiently absorbed. Therefore, in the side margin 17, the crack loses a driving force at the glass particle G, and thus the growth of the crack is stopped.

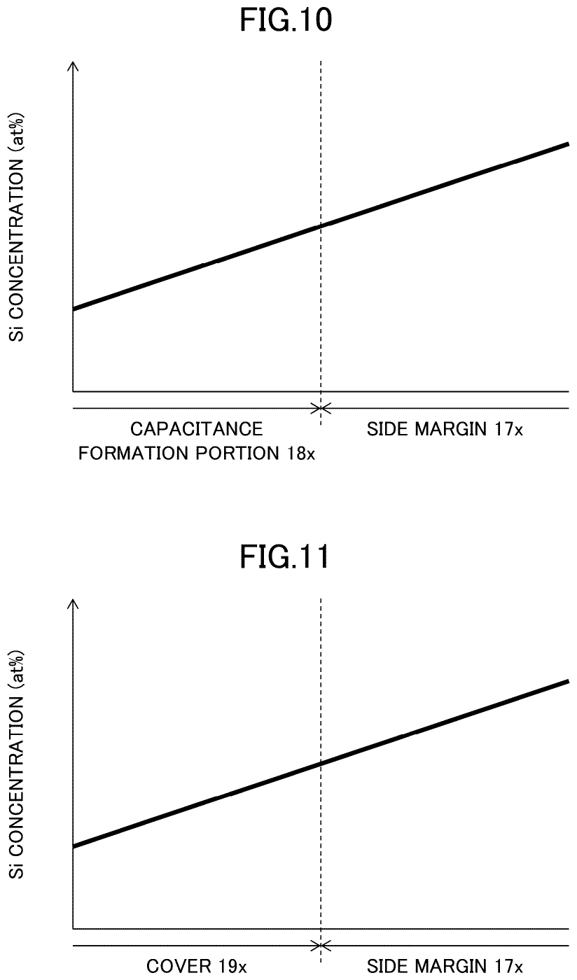

Here, as comparative examples, features of a multilayer ceramic capacitor including side margins formed using SiO₂ as a sintering aid will be described. FIG. 10 is a diagram illustrating an Si concentration distribution near a boundary between a capacitance formation portion and a side margin in comparative examples. FIG. 11 is a diagram illustrating an Si concentration distribution near a boundary between a cover and the side margin in the comparative examples.

When SiO₂ is used as a sintering aid, diffusion of Si ions occurs during firing as described above. Therefore, as illustrated in FIG. 10, the Si concentration continuously increases from a capacitance formation portion 18x to a pair of side margins 17x at the boundaries between the capacitance formation portion 18x and the pair of side margins 17x. Also, as illustrated in FIG. 11, the Si concentration continuously increases from a cover 19x to the pair of side margins 17x at the boundaries between the cover 19x and the pair of side margins 17x.

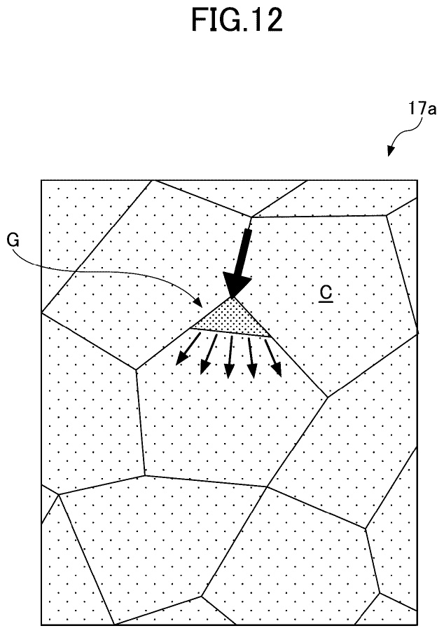

FIG. 12 is a partial cross-sectional diagram schematically illustrating a microstructure of the side margin 17x in comparative examples. In the side margin 17x, unlike the side margin 17 in the first embodiment, the glass particle G is much smaller than the crystal particles C, and the glass particle G exists at the grain boundary or the grain boundary triple point of the crystal particles C.

In the side margin 17x, the small glass particle G cannot sufficiently absorb energy applied from the crack, and the energy is applied to the surrounding crystal particles C and grain boundaries through the glass particle G. Thus, in the side margin 17x, growth of the crack does not stop at the glass particle G, and the crack tends to grow beyond the glass particle G.

As described above, in the present embodiment, the glass particle G in the side margin 17 has a size equal to or larger than the size of the crystal particles C. Thus, unlike the comparative examples, the effect of the glass particle G to stop growth of cracks can be effectively obtained. With this, formation of large cracks can be suppressed in the side margin 17.

In the side margin 17, preferably, the median diameter of the glass particles G is 0.20 μm or more and is 90% or more of the median diameter of the crystal particles C forming the polycrystalline substance. Thus, the side margin 17 can sufficiently absorb energy of the crack at the glass particles G.

The median diameter is defined as a median of particle sizes of the particles existing within a predetermined field of view in a cross section, and can be determined, for example, in a rectangular field of view of 30 μm×40 μm in a cross section of the side margin 17. The particle size of each particle can be obtained as a circle equivalent diameter that is calculated as the diameter of a circle having an area equal to that of a cross section of each particle.

In the side margin 17, when the glass particles G are too large, flexibility becomes too high. As a result, it becomes demanding to maintain a normal shape, e.g., the flatness of the outer surface is degraded in the manufacturing process. Therefore, it is preferable to maintain the median diameter of the glass particles G to be 0.80 μm or less in the side margin 17.

Further, by uniformly dispersing a sufficient number of glass particles G in the polycrystalline substance, it is possible to remarkably increase the probability that the glass particles G exist in the growing paths of cracks in the side margin 17. Thus, the growth of the cracks formed in the side margin 17 can be more reliably inhibited by the glass particles G.

Especially, it is possible to prevent cracks formed from the outer surface of the side margin 17 from penetrating through the side margin 17 in the Y-axis direction, and reaching the side surface F of the laminate 16. Thus, it is possible to prevent insulation failure of the multilayer ceramic capacitor 10 caused by moisture entering the side surface F of the laminate 16 through the cracks in the side margin 17.

In the multilayer ceramic capacitor 10, as the dimension of the side margin 17 in the Y-axis direction becomes smaller, cracks penetrating through the side margin 17 in the Y-axis direction are more likely to form. Therefore, when the multilayer ceramic capacitor 10 has a configuration in which the dimension of the side margin 17 in the Y-axis direction is 20 μm or less, it is possible to more effectively obtain the effect of preventing insulation failure of the multilayer ceramic capacitor 10.

Specifically, in the side margin 17, the percentage of the total volume of portions where the glass particles G exist relative to the total volume of portions where the polycrystalline substance exists (total volume ratio) is preferably 1% or more. This can sufficiently increase the probability that the glass particles G exist in the growing paths of cracks in the side margin 17.

The total volume ratio of the glass particles G to the polycrystalline substance in the side margin 17 can be estimated from the particle size of the glass particles G existing within a predetermined field of view in a cross section of the side margin 17. For example, the cross section of the side margin 17 can be obtained in a photograph taken using a scanning electron microscope (SEM) in a rectangular field of view of 30 μm×40 μm.

Specifically, using the area measured for each glass particle G having the maximum diameter of 0.05 μm or more from the photograph of the cross section of the side margin 17, the diameter of each glass particle G is calculated as a circle equivalent diameter, and a sphere equivalent volume of each glass particle G is calculated from the obtained diameter. Thereby, an average volume of the glass particles G can be obtained. Next, the number of glass particles G in the entirety of the side margin 17 can be roughly calculated from the number of glass particles G in a square region having an area of 1 μm². Thus, the total volume of the glass particles G can be obtained by multiplying the average volume by the number of glass particles G. The total volume ratio of the glass particles G can be obtained as a ratio of the total volume of the glass particles G to the volume of the polycrystalline substance obtained by subtracting the total volume of the glass particles G from the total volume of the side margin 17.

In the side margin 17, when the total volume ratio of the glass particles G to the volume of the polycrystalline substance is too high, flexibility becomes too high. As a result, it becomes demanding to maintain a normal shape, e.g., the flatness of the outer surface is degraded in the manufacturing process. Therefore, it is preferable to maintain the percentage of the total volume of the glass particles G relative to the total volume of the polycrystalline substance to be 20% or less in the side margin 17.

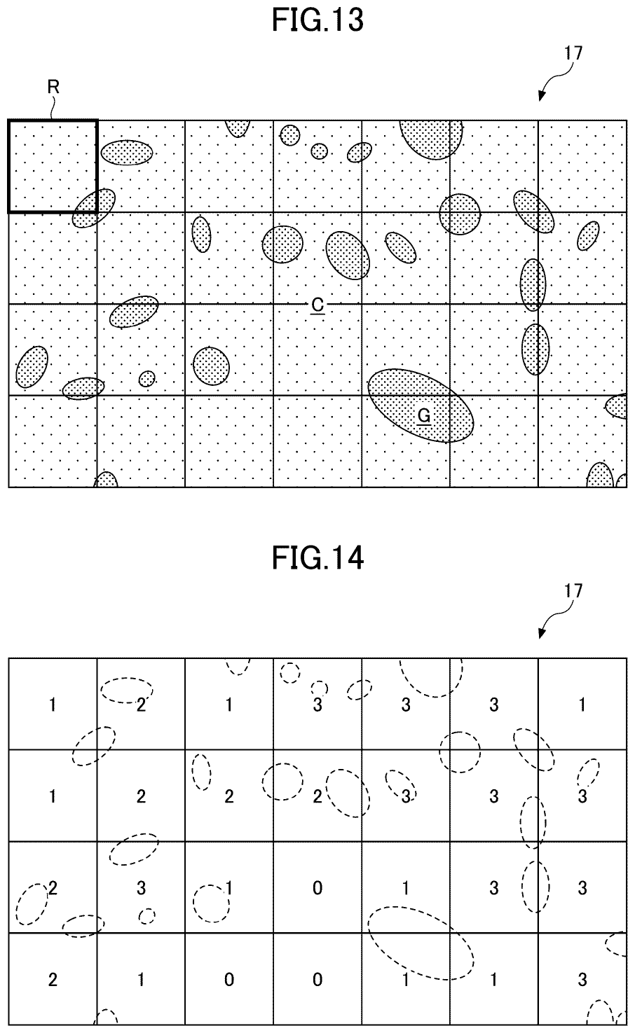

FIGS. 13 and 14 are diagrams for describing an evaluation method of a frequency of the presence of the glass particles G in the side margin 17. FIG. 13 is a partial cross-sectional diagram schematically illustrating the distribution state of the glass particles in the side margin 17. FIG. 14 is a diagram schematically illustrating the distribution state of the glass particles in the side margin 17. FIG. 13 illustrates a plurality of square regions R arranged in a lattice form on the cross section of the side margin 17. The area of each region R is 1 μm². A plurality of regions R may be arranged, for example, in 4 rows and 7 columns.

FIG. 14 illustrates the number of the glass particles G observed in each region R in a field of view the same as in FIG. 13. Even if the glass particle G is partially observed in each region R, the partially observed glass particle G is counted as 1. In the present embodiment, the frequency of the presence of the glass particles G in the side margin 17 is evaluated in accordance with the average number of glass particles G among the plurality of regions R.

Specifically, it is preferable that in the side margin 17 in the present embodiment, the average number of glass particles G among all the arranged regions R is 0.5 or more and 2 or less per 1 μm². It is also preferable that in the side margin 17, the standard deviation of the number of glass particles G per 1 μm² among all the arranged regions R is 0.30 or less.

With this, a high extent of dispersibility of the glass particles G is obtained in the polycrystalline substance formed of the crystal particles C in the side margin 17, and the frequency of the presence of the glass particles G becomes appropriate. Therefore, this can sufficiently increase the probability that the glass particles G exist in the growing paths of cracks in the side margin 17 while suppressing an increase in flexibility caused by the glass particles G.

When the cross section of the multilayer ceramic capacitor 10 is irradiated with white light, the side margin 17 appears whiter than the laminate 16 due to reflection from the glass particles G. When the cover 19 contains no Si, the cover 19 appears especially black. However, the pair of covers 19 may be formed of a material that is the same as that of the pair of side margins 17. In this case, the side margin 17 and the cover 19 appear whiter than the capacitance formation portion 18.

Here, the side margin 17 appears white because the Si concentration is high. Compared to the comparative examples whose Si concentration distributions are indicated in FIGS. 10 and 11, Si is contained in a high-molecular-weight form in the present embodiment, and thus a large number of Si atoms remain in the side margin 17 without being diffused into the capacitance formation portion 18.

Further, in the cross-sectional diagram of FIG. 3, when the side margin 17 is viewed in the Y direction from the side surface toward the capacitance formation portion 18, the side surface appears white, and the side margin 17 on the capacitance formation portion 18 side appears less white than the side surface. This is because Si atoms are slightly diffused into the capacitance formation portion 18.

On the other hand, in the comparative examples whose Si concentration distributions are indicated in FIGS. 10 and 11, SiO₂ added to the side margin 17x is considerably diffused into the capacitance formation portion 18x, resulting in a great difference in whiteness between the side surface and the capacitance formation portion 18x side. This is because a smaller number of Si atoms remain in the side margin 17x.

Therefore, the side margin 17 of the present embodiment can maintain whiteness in the Y direction compared to the side margin 17x of the comparative examples.

In addition, the Si concentration discontinuously increases from the capacitance formation portion 18 to the pair of covers 19 (outermost ceramic layers 22), and more excellent moisture resistance can be obtained. In this case, at the boundaries between the capacitance formation portion 18 and the pair of covers 19, the difference in the Si concentration is preferably 4 at % or more, and more preferably 5 at % or more.

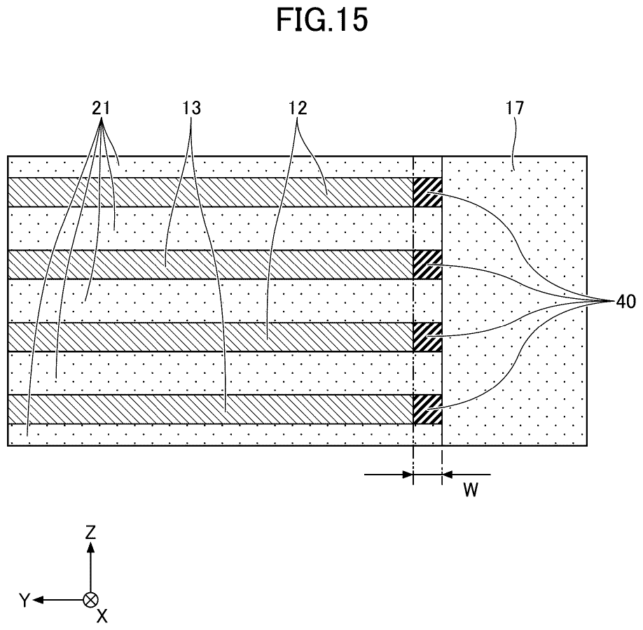

The end of the first internal electrode 12 that contacts the side margin 17 and the end of the second internal electrode 13 that contacts the side margin 17 may be slightly oxidized. FIG. 15 is a cross-sectional diagram illustrating the internal electrodes that are partially oxidized. However, dimensions W, in the Y-axis direction, of oxidized regions 40 formed at the ends of the first internal electrode 12 and the second internal electrode 13 is preferably 1 μm or less on average. The dimensions W of the oxidized regions can be measured, for example, using a cross-sectional scanning electron microscope (SEM).

When the pair of side margins 17 include a polycrystalline substance having a perovskite structure containing barium at A site and titanium at B site, the atomic ratio of Si to titanium at B site is preferably 9 at % or less in the pair of side margins 17. This is because when the atomic ratio of Si to titanium at B site is more than 9 at %, the organosilicon compound used for the formation of the side margin 17 becomes excessive, and thus sinterability may be lowered. Further, from the viewpoint of the effect of increasing densification, the atomic ratio of Si to titanium at B site is preferably 1 at % or more, and more preferably 3 at % or more.

Quantitative analysis of the respective elements can be performed, for example, through laser ablation inductively coupled plasma mass spectrometry (LA-ICP-MS).

### Second Embodiment

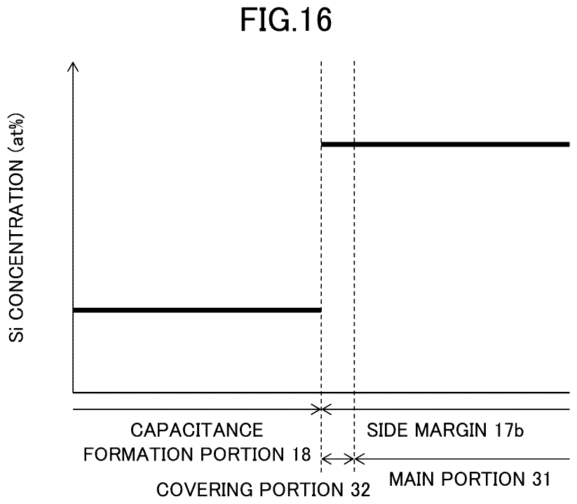

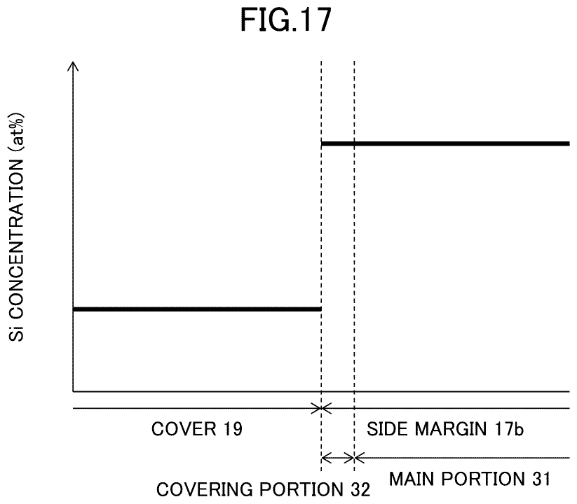

Next, the second embodiment will be described. The second embodiment is different from the first embodiment mainly in the forming method and configurations of the side margins. FIG. 16 is a diagram illustrating an Si concentration distribution near a boundary between a capacitance formation portion and a side margin in the second embodiment. FIG. 17 is a diagram illustrating an Si concentration distribution near a boundary between a cover and the side margin in the second embodiment.

A multilayer ceramic capacitor according to the second embodiment includes a pair of side margins 17b instead of the pair of side margins 17 in the first embodiment. The pair of side margins 17b each include a main portion 31 and a covering portion 32. The covering portion 32 covers a surface of the main portion 31 facing the laminate 16, and is located between the laminate 16 and the main portion 31. For example, the main portion 31 is formed of a material that is the same as that of the inter-electrode ceramic layers 21, and, like the side margin 17, the covering portion 32 contains Si at a higher concentration than that in the laminate 16. Therefore, as illustrated in FIG. 16, at the boundaries between the capacitance formation portion 18 and a pair of covering portions 32, the Si concentration discontinuously increases from the capacitance formation portion 18 to the pair of covering portions 32. Also, as illustrated in FIG. 17, at the boundaries between the covers 19 and the pair of covering portions 32, the Si concentration discontinuously increases from the covers 19 to the pair of covering portions 32.

The other configurations of the second embodiment are the same as those of the first embodiment.

In manufacturing the multilayer ceramic capacitor according to the second embodiment, first, the laminate 16 is provided in step S01 as in the first embodiment.

Next, in step S02, an unfired main portion 31 is provided instead of the unfired side margin 17. Also, a dispersion liquid in which an organosilicon compound, a binder, and a barium-containing compound are mixed together is applied through spray coating to a surface of the unfired main portion 31 facing the laminate 16. The barium-containing compound is, for example, barium carbonate. Then, in step S02, the unfired main portion 31, to which the dispersion liquid has been applied, is provided at the pair of side surfaces F of the unfired laminate 16.

Subsequently, like in the first embodiment, firing is performed in step S03, thereby forming the first external electrode 14 and the second external electrode 15 in step S04. By the firing, the covering portion 32 is formed at the portions to which the dispersion liquid has been applied.

In this manner, the multilayer ceramic capacitor according to the second embodiment can be manufactured.

In the second embodiment, like in the first embodiment, the side margins 17b are highly densified, and excellent moisture resistance can be obtained. Therefore, even if the side margins 17b are thin, entry of moisture from the exterior into the side margins 17b can be suppressed, and oxidation of the first internal electrodes 12 and the second internal electrodes 13 can be suppressed.

Also, excellent moisture resistance is obtained especially near the interface between the cover 19 and the side margin 17b. With this, even if a slight extent of delamination occurs between the cover 19 and the side margin 17b, oxidation of the first internal electrodes 12 and the second internal electrodes 13 can be suppressed.

The main portion 31 may be formed of a material that is the same as that of the side margins 17 of the first embodiment. In this case, more excellent moisture resistance can be obtained.

The Si concentration does not necessarily need to discontinuously increase from the laminate 16 to the pair of side margins 17 or 17b in the entirety of the boundaries between the laminate 16 and the pair of side margins 17 or 17b. When the Si concentration discontinuously increases from the laminate 16 to the pair of side margins 17 or 17b at least at a part of the boundaries between the laminate 16 and the pair of side margins 17 or 17b, it is possible to obtain moisture resistance more excellent than that of existing multilayer ceramic capacitors.

For example, when the Si concentration discontinuously increases from the covers 19 to the pair of side margins 17 or 17b at the boundaries between the covers 19 and the pair of side margins 17 or 17b, the Si concentration does not necessarily need to discontinuously increase from the capacitance formation portion 18 to the pair of side margins 17 or 17b at the boundaries between the capacitance formation portion 18 and the pair of side margins 17 or 17b. In this case, excellent moisture resistance is obtained near the interface between the covers 19 and the side margins 17 or 17b, and thus even if a slight extent of delamination occurs between the covers 19 and the side margins 17 or 17b, oxidation of the first internal electrodes 12 and the second internal electrodes 13 can be suppressed.

Conversely, when the Si concentration discontinuously increases from the capacitance formation portion 18 to the pair of side margins 17 or 17b at the boundaries between the capacitance formation portion 18 and the pair of side margins 17 or 17b, the Si concentration does not necessarily need to discontinuously increase from the covers 19 to the pair of side margins 17 or 17b at the boundaries between the covers 19 and the pair of side margins 17 or 17b. In this case, excellent moisture resistance is obtained near the interface between the capacitance formation portion 18 and the side margins 17 or 17b, and thus oxidation of the first internal electrodes 12 and the second internal electrodes 13 included in the capacitance formation portion 18 can be suppressed.

### Third Embodiment

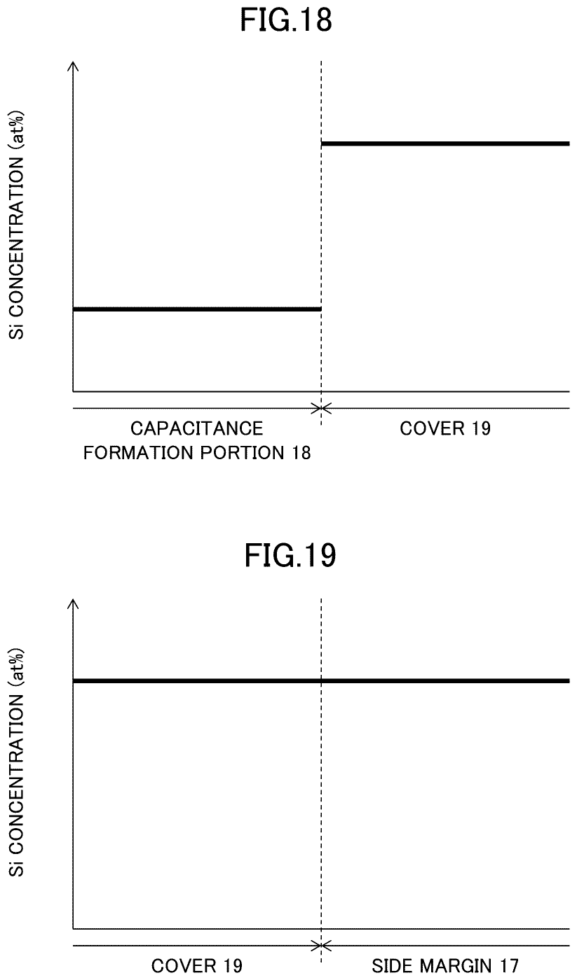

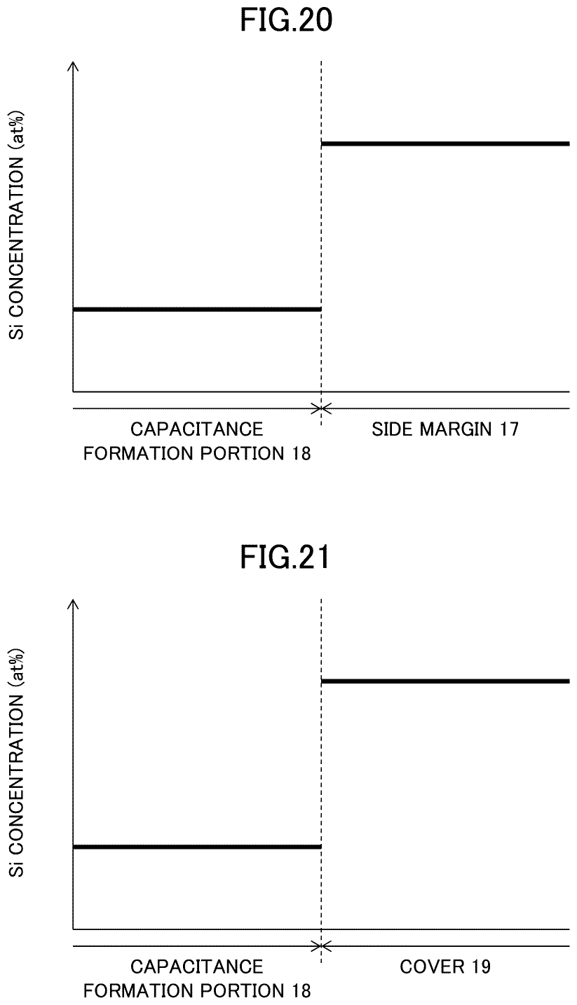

Next, the third embodiment will be described. The third embodiment is different from the first embodiment mainly in the configuration of the covers. FIG. 18 is a diagram illustrating an Si concentration distribution near a boundary between a capacitance formation portion and a cover in the third embodiment. FIG. 19 is a diagram illustrating an Si concentration distribution near a boundary between the cover and a side margin in the third embodiment. FIG. 20 is a diagram illustrating an Si concentration distribution near a boundary between the capacitance formation portion and the side margin in the third embodiment.

In the present embodiment, an organosilicon compound is used as a sintering aid not only for the formation of the side margins 17 but also for the formation of the outermost ceramic layers 22 included in the covers 19, and Si is contained in the side margins 17 and the outermost ceramic layers 22. The side margins 17 and the outermost ceramic layers 22 may contain glass particles that contain Si as a main component. On the other hand, no organosilicon compound is used for the formation of the inter-electrode ceramic layers 21 included in the capacitance formation portion 18, and the Si concentration in the inter-electrode ceramic layers 21 is lower than the Si concentration in the side margins 17 and the Si concentration in the outermost ceramic layers 22. The inter-electrode ceramic layers 21 may be substantially free of Si. As illustrated in FIG. 18, at the boundaries between the capacitance formation portion 18 and the pair of covers 19, the Si concentration discontinuously increases from the capacitance formation portion 18 to the pair of covers 19. Also, as illustrated in FIG. 19, the Si concentration in the pair of covers 19 and the Si concentration in the pair of side margins 17 are equal. Also, as illustrated in FIG. 20, at the boundaries between the capacitance formation portion 18 and the pair of side margins 17, the Si concentration discontinuously increases from the capacitance formation portion 18 to the pair of side margins 17. At the boundaries between the capacitance formation portion 18 and the pair of covers 19, the difference in the Si concentration is preferably 4 at % or more, and more preferably 5 at % or more. In the present disclosure, when the Si concentration is measured in a first 3-μm region from the boundary toward the cover 19 and a second 3-μm region from the boundary toward the capacitance formation portion 18, if the difference in the Si concentration between the first 3-μm region and the second 3-μm region is 4 at % or more, this corresponds to “the Si concentration discontinuously increases”.

The other configurations of the third embodiment are the same as those of the first embodiment.

In the multilayer ceramic capacitor according to the third embodiment, an organosilicon compound is used as a sintering aid for the covers 19, and the Si concentration discontinuously increases from the capacitance formation portion 18 to the pair of covers 19 at the boundaries between the capacitance formation portion 18 and the pair of covers 19. Thus, the covers 19 are highly densified, and excellent moisture resistance can be obtained. Therefore, entry of moisture into the covers 19 can be suppressed, and oxidation of the first internal electrodes 12 and the second internal electrodes 13 can be suppressed.

### Fourth Embodiment

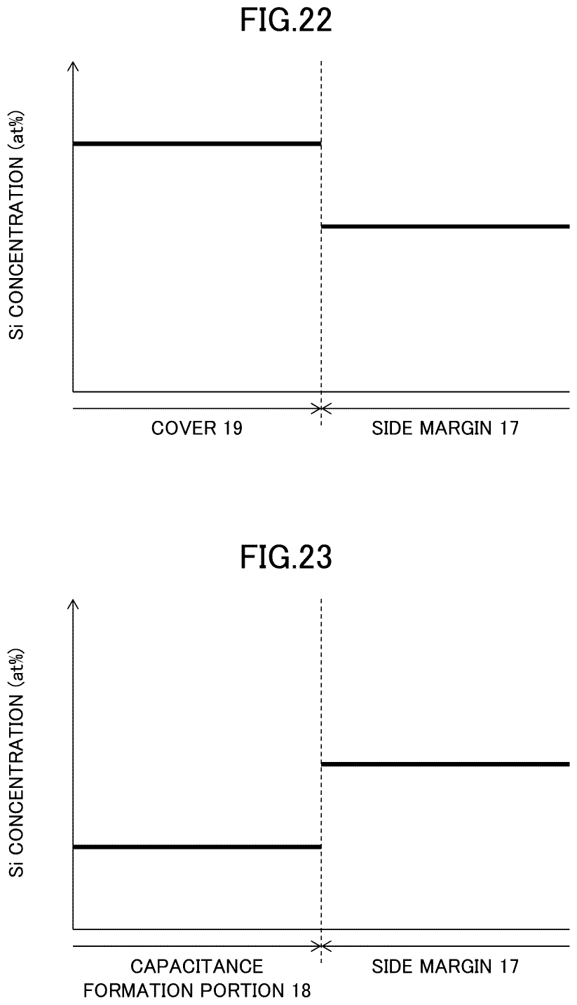

Next, the fourth embodiment will be described. The fourth embodiment is different from the third embodiment mainly in the configurations of the covers and the side margins. FIG. 21 is a diagram illustrating an Si concentration distribution near a boundary between a capacitance formation portion and a cover in the fourth embodiment. FIG. 22 is a diagram illustrating an Si concentration distribution near a boundary between the cover and a side margin in the fourth embodiment. FIG. 23 is a diagram illustrating an Si concentration distribution near a boundary between the capacitance formation portion and the side margin in the fourth embodiment.

In the present embodiment, an organosilicon compound is used as a sintering aid not only for the formation of the side margins 17 but also for the formation of the outermost ceramic layers 22 included in the covers 19, and Si is contained in the side margins 17 and the outermost ceramic layers 22. On the other hand, no organosilicon compound is used for the formation of the inter-electrode ceramic layers 21 included in the capacitance formation portion 18, and the Si concentration in the inter-electrode ceramic layers 21 is lower than the Si concentration in the side margins 17 and the Si concentration in the outermost ceramic layers 22. The inter-electrode ceramic layers 21 may be substantially free of Si. Also, the Si concentration in the outermost ceramic layers 22 is higher than the Si concentration in the side margins 17. As illustrated in FIG. 21, at the boundaries between the capacitance formation portion 18 and the pair of covers 19, the Si concentration discontinuously increases from the capacitance formation portion 18 to the pair of covers 19. Also, as illustrated in FIG. 22, at the boundaries between the pair of covers 19 and the pair of side margins 17, the Si concentration discontinuously increases from the pair of side margins 17 to the pair of covers 19. Also, as illustrated in FIG. 23, at the boundaries between the capacitance formation portion 18 and the pair of side margins 17, the Si concentration discontinuously increases from the capacitance formation portion 18 to the pair of side margins 17.

The other configurations of the fourth embodiment are the same as those of the third embodiment.

In the multilayer ceramic capacitor according to the fourth embodiment, an organosilicon compound is used as a sintering aid for the covers 19, and the Si concentration discontinuously increases from the capacitance formation portion 18 to the pair of covers 19 at the boundaries between the capacitance formation portion 18 and the pair of covers 19. Therefore, the fourth embodiment can provide the same effects as those of the third embodiment.

### Fifth Embodiment

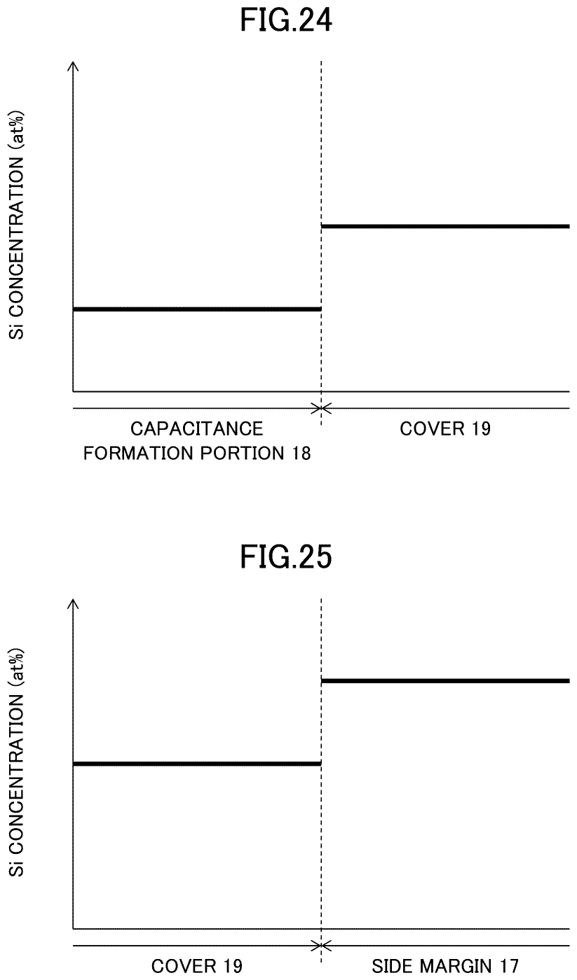

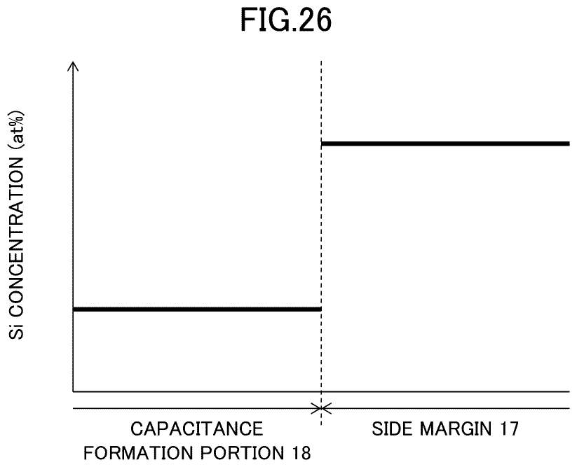

Next, the fifth embodiment will be described. The fifth embodiment is different from the third embodiment mainly in the configurations of the covers and the side margins. FIG. 24 is a diagram illustrating an Si concentration distribution near a boundary between a capacitance formation portion and a cover in the fifth embodiment. FIG. 25 is a diagram illustrating an Si concentration distribution near a boundary between the cover and a side margin in the fifth embodiment. FIG. 26 is a diagram illustrating an Si concentration distribution near a boundary between the capacitance formation portion and the side margin in the fifth embodiment.

In the present embodiment, an organosilicon compound is used as a sintering aid not only for the formation of the side margins 17 but also for the formation of the outermost ceramic layers 22 included in the covers 19, and Si is contained in the side margins 17 and the outermost ceramic layers 22. On the other hand, no organosilicon compound is used for the formation of the inter-electrode ceramic layers 21 included in the capacitance formation portion 18, and the Si concentration in the inter-electrode ceramic layers 21 is lower than the Si concentration in the side margins 17 and the Si concentration in the outermost ceramic layers 22. The inter-electrode ceramic layers 21 may be substantially free of Si. Also, the Si concentration in the side margins 17 is higher than the Si concentration in the outermost ceramic layers 22. As illustrated in FIG. 24, at the boundaries between the capacitance formation portion 18 and the pair of covers 19, the Si concentration discontinuously increases from the capacitance formation portion 18 to the pair of covers 19. Also, as illustrated in FIG. 25, at the boundaries between the pair of covers 19 and the pair of side margins 17, the Si concentration discontinuously increases from the pair of covers 19 to the pair of side margins 17. Also, as illustrated in FIG. 26, at the boundaries between the capacitance formation portion 18 and the pair of side margins 17, the Si concentration discontinuously increases from the capacitance formation portion 18 to the pair of side margins 17.

The other configurations of the fifth embodiment are the same as those of the third embodiment.

In the multilayer ceramic capacitor according to the fifth embodiment, an organosilicon compound is used as a sintering aid for the covers 19, and the Si concentration discontinuously increases from the capacitance formation portion 18 to the pair of covers 19 at the boundaries between the capacitance formation portion 18 and the pair of covers 19. Therefore, the fifth embodiment can provide the same effects as those of the third embodiment.

### EXAMPLES AND COMPARATIVE EXAMPLES

As Examples and Comparative Examples of the above embodiments, samples of multilayer ceramic capacitors having different configurations of the side margins (SM) and the covers were prepared. The size of each of the samples of Comparative Examples 1 and 2 and Examples 3 to 25 was set to a 0603 size, in which the dimension in the X-axis direction was 0.6 millimeters (mm), the dimension in the Y-axis direction was 0.3 mm, and the dimension in the Z-axis direction was 0.3 mm. The main components of the side margins and the covers were barium titanate.

In Comparative Examples 1 and 2, the thickness of a side margin sheet (SM sheet) used to form the side margin was 10 μm or 20 μm, and SiO₂ was used as an Si source contained in a sintering aid. In Examples 3 to 25, the thickness of a side margin sheet used to form the side margin was 5 μm, 10 μm, 20 μm, or 30 μm, and an organosilicon compound was used as an Si source contained in a sintering aid.

The Si concentration in the side margin sheet was the same among Comparative Examples 1 and 2 and Examples 3, 4, 7 to 9, 13, and 20. The Si concentration in the side margin sheet in Example 17 was lower than that in these comparative examples and examples. The Si concentration in the side margin sheet in Examples 5, 10, 14, and 21 was lower than that in Example 17. Also, the Si concentration in the side margin sheet in Examples 6, 11, 18, 22, and 24 was lower than that in Examples 5, 10, 14, and 21. The Si concentration in the side margin sheet in Examples 12, 15, 16, 19, 23, and 25 was lower than that in Examples 6, 11, 18, 22, and 24.

The Si concentration in the cover was the same among Comparative Examples 1 and 2 and Examples 1 to 8. The Si concentration in the cover in Example 25 was higher than that in these comparative examples and examples. The Si concentration in the cover in Examples 23 and 24 was higher than that in Example 25. The Si concentration in the cover in Examples 12 and 22 was higher than that in Examples 23 and 24. Also, the Si concentration in the cover in Examples 11, 19, and 21 was higher than that in Examples 12 and 22. The Si concentration in the cover in Examples 10 and 18 was higher than that in Examples 11, 19, and 21. The Si concentration in the cover in Example 20 was higher than that in Examples 10 and 18. Also, the Si concentration in the cover in Examples 9 and 17 was higher than that in Example 20. The Si concentration in the cover in Examples 13 to 15 was higher than that in Examples 9 and 17. The Si concentration in the cover in Example 16 was higher than that in Examples 13 to 15.

The samples prepared in Comparative Examples 1 and 2 and Examples 3 to 25 were studied for the following various characteristics, and overall determination was performed from obtained results.

The Si concentration in the laminate and the side margin was measured through laser ablation inductively coupled plasma mass spectrometry. A form of the Si distribution in the laminate and the side margin was studied, and the difference in the Si concentration at the boundary between the laminate and the side margin was calculated. A form of the Si distribution similar to that of the Si distribution illustrated in FIGS. 4 and 5 was evaluated as “A”, a form of the Si distribution similar to that of the Si distribution illustrated in FIGS. 10 and 11 was evaluated as “B”. Also, a form of the Si distribution similar to that of the Si distribution illustrated in FIGS. 18 to 20 was evaluated as “C”, a form of the Si distribution similar to that of the Si distribution illustrated in FIGS. 21 to 23 was evaluated as “D”, and a form of the Si distribution similar to that of the Si distribution illustrated in FIGS. 24 to 26 was evaluated as “E”. Difference X1 in the Si concentration is a difference between the concentration at a measurement point in the side margin closest to the capacitance formation portion and the concentration at a measurement point in the capacitance formation portion closest to the side margin. Difference X2 in the Si concentration is a difference between the concentration at a measurement point in the side margin closest to the cover and the concentration at a measurement point in the cover the closest to the side margin. Difference X3 in the Si concentration is a difference between the concentration at a measurement point in the capacitance formation portion the closest to the cover and the concentration at a measurement point in the cover closest to the capacitance formation portion.

The dimensions W, in the Y-axis direction, of oxidized regions at the ends of the internal electrodes were measured, and an average value of the dimensions W was evaluated in 3 steps. The dimensions W of the oxidized regions were measured using a cross-sectional SEM. One hundred samples of each of the examples and the comparative examples were measured for the dimensions W, and an average value of the measured dimensions W was calculated. The average value of 0 μm or more and 1 μm or less was evaluated as “A”, the average value of more than 1 μm and 3 μm or less was evaluated as “B”, and the average value of more than 3 μm was evaluated as “C”.

The capacitance was measured using an LCR meter as electric characteristics. The reduction in the capacitance of 0% or more and 5% or less from the designed value of the capacitance was evaluated as “A”, the reduction in the capacitance of more than 5% and 10% or less from the designed value of the capacitance was evaluated as “B”, and the reduction in the capacitance of more than 10% from the designed value of the capacitance was evaluated as “C”.

The moisture resistance was evaluated. For evaluation of the moisture resistance, 100 samples of each of the examples and the comparative examples were retained in an environment of 85 degrees Celsius (° C.) and 85% humidity for 100 hours, and the capacitance was measured after the retention. The samples in which the reduction in the capacitance from the designed value of the capacitance was 0% or more and 5% or less and that were free of cracks were each regarded as a “non-defective product”. The samples in which the reduction in the capacitance from the designed value of the capacitance was not 0% or more and 5% or less, and that included cracks were each regarded as a “defective product”. The samples in which the percentage of the formed defective products was 0% or more and 5% or less were regarded as “A”, the samples in which the percentage of the formed defective products was more than 5% and 10% or less were regarded as “B”, and the samples in which the percentage of the formed defective products was more than 10% were regarded as “C”.

The overall evaluation of the samples in which the evaluation of the dimensions W of the oxidized regions was “A” or “B”, the evaluation of the electric characteristics was “A”, and the evaluation of the moisture resistance was “A”, was regarded as “A”. The overall evaluation of the samples in which at least one of the evaluation of the dimensions W of the oxidized regions, the evaluation of the electric characteristics, or the evaluation of the moisture resistance was “C”, was regarded as “C”. The overall evaluation of the samples in which the overall evaluation was not “A” or “C”, was regarded as “B”. These results are presented in Tables 1 to 3. In Tables 1 to 3, “Diff.” stands for “Difference” and “conc.” stands for “concentration”.

TABLE 1

| | | | | | Diff. | Diff. | Diff. | Dimen- | | | |
|---|---|---|---|---|---|---|---|---|---|---|---|
| | | | | | X1 | X2 | X3 | sion W | | | |
| | | | Thickness | Distri- | in Si | in Si | in Si | of | Electric | | Overall |
| | Si source | Si source | of SM | bution | conc. | conc. | conc. | oxidized | character- | Moisture | evalu- |
| | of SM | of cover | sheet (μm) | of Si | (at %) | (at %) | (at %) | region | istics | Resistance | ation |
| Comp. | SiO₂ | SiO₂ | 10 | B | 0 | 0 | 0 | C | C | C | C |
| Ex. 1 | | | | | | | | | | | |
| Comp. | SiO₂ | SiO₂ | 20 | B | 0 | 0 | 0 | C | C | B | C |
| Ex. 2 | | | | | | | | | | | |
| Ex. 3 | Organo- | SiO₂ | 5 | A | 9 | 9 | 0 | B | B | B | B |
| | silicon | | | | | | | | | | |
| | compound | | | | | | | | | | |
| Ex. 4 | Organo- | SiO₂ | 10 | A | 9 | 9 | 0 | A | A | A | A |
| | silicon | | | | | | | | | | |
| | compound | | | | | | | | | | |
| Ex. 5 | Organo- | SiO₂ | 20 | A | 5 | 5 | 0 | A | A | A | A |
| | silicon | | | | | | | | | | |
| | compound | | | | | | | | | | |
| Ex. 6 | Organo- | SiO₂ | 20 | A | 4 | 4 | 0 | B | A | A | A |
| | silicon | | | | | | | | | | |
| | compound | | | | | | | | | | |
| Ex. 7 | Organo- | SiO₂ | 20 | A | 9 | 9 | 0 | A | A | A | A |
| | silicon | | | | | | | | | | |
| | compound | | | | | | | | | | |
| Ex. 8 | Organo- | SiO₂ | 30 | A | 9 | 9 | 0 | A | A | A | A |
| | silicon | | | | | | | | | | |
| | compound | | | | | | | | | | |
| Ex. 9 | Organo- | Organo- | 20 | C | 9 | 0 | 9 | A | A | A | A |
| | silicon | silicon | | | | | | | | | |
| | compound | compound | | | | | | | | | |
| Ex. 10 | Organo- | Organo- | 20 | C | 5 | 0 | 5 | A | A | A | A |
| | silicon | silicon | | | | | | | | | |
| | compound | compound | | | | | | | | | |

Diff. X1 in Si conc.: Difference between the concentration at a measurement point in the side margin closest to the capacitance formation portion and the concentration at a measurement point in the capacitance formation portion closest to the side margin
Diff. X2 in Si conc.: Difference between the concentration at a measurement point in the side margin closest to the cover and the concentration at a measurement point in the cover closest to the side margin
Diff. X3 in Si conc.: Difference between the concentration at a measurement point in the capacitance formation portion closest to the cover and the concentration at a measurement point in the cover closest to the capacitance formation portion

TABLE 2

| | | | | | Diff. | Diff. | Diff. | Dimen- | | | |
|---|---|---|---|---|---|---|---|---|---|---|---|
| | | | Thickness | | X1 | X2 | X3 | sion W | | | |
| | | | of SM | Distri- | in Si | in Si | in Si | of | Electric | | Overall |
| | Si source | Si source | sheet | bution | conc. | conc. | conc. | oxidized | character- | Moisture | evalu- |
| | of SM | of cover | (μm) | of Si | (at %) | (at %) | (at %) | region | istics | resistance | ation |
| Ex. 11 | Organo- | Organo- | 20 | C | 4 | 0 | 4 | A | A | A | A |
| | silicon | silicon | | | | | | | | | |
| | compound | compound | | | | | | | | | |
| Ex. 12 | Organo- | Organo- | 20 | C | 3 | 0 | 3 | B | A | A | A |
| | silicon | silicon | | | | | | | | | |
| | compound | compound | | | | | | | | | |
| Ex. 13 | Organo- | Organo- | 20 | D | 9 | 1 | 10 | A | A | A | A |
| | silicon | silicon | | | | | | | | | |
| | compound | compound | | | | | | | | | |
| Ex. 14 | Organo- | Organo- | 20 | D | 5 | 5 | 10 | A | A | A | A |
| | silicon | silicon | | | | | | | | | |
| | compound | compound | | | | | | | | | |
| Ex. 15 | Organo- | Organo- | 20 | D | 3 | 7 | 10 | B | A | A | A |
| | silicon | silicon | | | | | | | | | |
| | compound | compound | | | | | | | | | |
| Ex. 16 | Organo- | Organo- | 20 | D | 3 | 8 | 11 | B | A | A | A |
| | silicon | silicon | | | | | | | | | |
| | compound | compound | | | | | | | | | |
| Ex. 17 | Organo- | Organo- | 20 | D | 8 | 1 | 9 | A | A | A | A |
| | silicon | silicon | | | | | | | | | |
| | compound | compound | | | | | | | | | |
| Ex. 18 | Organo- | Organo- | 20 | D | 4 | 1 | 5 | A | A | A | A |
| | silicon | silicon | | | | | | | | | |
| | compound | compound | | | | | | | | | |
| Ex. 19 | Organo- | Organo- | 20 | D | 3 | 1 | 4 | B | A | A | A |
| | silicon | silicon | | | | | | | | | |
| | compound | compound | | | | | | | | | |
| Ex. 20 | Organo- | Organo- | 20 | E | 9 | 1 | 8 | A | A | A | A |
| | silicon | silicon | | | | | | | | | |
| | compound | compound | | | | | | | | | |

Diff. X1 in Si conc.: Difference between the concentration at a measurement point in the side margin closest to the capacitance formation portion and the concentration at a measurement point in the capacitance formation portion closest to the side margin
Diff. X2 in Si conc.: Difference between the concentration at a measurement point in the side margin closest to the cover and the concentration at a measurement point in the cover closest to the side margin
Diff. X3 in Si conc.: Difference between the concentration at a measurement point in the capacitance formation portion closest to the cover and the concentration at a measurement point in the cover closest to the capacitance formation portion

TABLE 3

| | | | | | Diff. | Diff. | Diff. | Dimen- | | | |
|---|---|---|---|---|---|---|---|---|---|---|---|
| | | | Thickness | | X1 | X2 | X3 | sion W | | | |
| | | | of SM | Distri- | in Si | in Si | in Si | of | Electric | | Overall |
| | Si source | Si source | sheet | bution | conc. | conc. | conc. | oxidized | character- | Moisture | evalu- |
| | of SM | of cover | (μm) | of Si | (at %) | (at %) | (at %) | region | istics | resistance | ation |
| Ex. 21 | Organo- | Organo- | 20 | E | 5 | 1 | 4 | A | A | A | A |
| | silicon | silicon | | | | | | | | | |
| | compound | compound | | | | | | | | | |
| Ex. 22 | Organo- | Organo- | 20 | E | 4 | 1 | 3 | A | A | A | A |
| | silicon | silicon | | | | | | | | | |
| | compound | compound | | | | | | | | | |
| Ex. 23 | Organo- | Organo- | 20 | E | 3 | 1 | 2 | B | A | A | A |
| | silicon | silicon | | | | | | | | | |
| | compound | compound | | | | | | | | | |
| Ex. 24 | Organo- | Organo- | 20 | E | 4 | 2 | 2 | A | A | A | A |
| | silicon | silicon | | | | | | | | | |
| | compound | compound | | | | | | | | | |
| Ex. 25 | Organo- | Organo- | 20 | E | 3 | 2 | 1 | B | A | A | A |
| | silicon | silicon | | | | | | | | | |
| | compound | compound | | | | | | | | | |

Diff. X1 in Si conc.: Difference between the concentration at a measurement point in the side margin closest to the capacitance formation portion and the concentration at a measurement point in the capactiance formation portion closest to the side margin
Diff. X2 in Si conc.: Difference between the concentration at a measurement point in the side margin closest to the cover and the concentration at a measurement point in the cover closest to the side margin
Diff. X3 in Si conc.: Difference between the concentration at a measurement point in the capacitance formation portion closest to the cover and the concentration at a measurement point in the cover closest to the capacitance formation portion

As presented in Tables 1 to 3, in Examples 3 to 8, the form of the Si distribution was “A”, and the overall evaluation was “A” or “B”. That is, in Examples 3 to 8, the organosilicon compound was used as the Si source for the side margins, the Si concentration discontinuously increased from the laminate to the pair of side margins at the boundaries between the laminate and the pair of side margins, and excellent moisture resistance and excellent electric characteristics were obtained. When comparing Example 3 with Examples 4, 7, and 8, the obtained moisture resistance and the obtained electric characteristics were more excellent in Examples 4, 7, and 8, having thicker side margin sheets, than in Example 3. Among Examples 4 to 6 using the side margin sheets having the same thickness, the dimensions W of the oxidized regions were smaller in Examples 4 and 5, having higher Si concentration in the side margin sheets, than in Example 6.

Further, when comparing Examples 3 to 11, 13, 14, 17, 18, 20 to 22, and 24 with Examples 12, 15, 16, 19, 23, and 25, the dimensions W of the oxidized regions were smaller in Examples 3 to 11, 13, 14, 17, 18, 20 to 22, and 24, having the difference X1 in the Si concentration higher than 3 at %, than in Examples 12, 15, 16, 19, 23, and 25.

On the other hand, in Comparative Examples 1 and 2, the form of the Si distribution was “B”, and the overall evaluation was “C”. That is, in Comparative Example 1, SiO₂ was used as the Si source, the Si concentration continuously increased from the laminate to the pair of side margins at the boundaries between the laminate and the pair of side margins, and the moisture resistance and the electric characteristics were low. In Comparative Example 2, the evaluation of the moisture resistance was “B” because the side margin sheet was thick, but the electric characteristics were low because Si was diffused from the side margins into the laminate.

### Other Embodiments

Although the embodiments have been described above in detail, the present disclosure is not limited to the specific embodiments, and various modifications and changes are possible within the scope of claims recited.

For example, the above embodiments have been described taking a multilayer ceramic capacitor as an example of a multilayer ceramic electronic component, but the present disclosure is applicable to all multilayer ceramic electronic components. Examples of such multilayer ceramic electronic components include chip varistors, chip thermistors, multilayer inductors, and the like.

Aspects of the present disclosure are as follows, for example.
<1> A multilayer ceramic electronic component, including:
a laminate including a plurality of ceramic layers laminated in a direction of a first axis, a plurality of internal electrodes one of which is located between each pair of adjacent ceramic layers of the plurality of ceramic layers, and a pair of side surfaces that are perpendicular to a second axis orthogonal to the first axis and at which ends of the plurality of internal electrodes in a direction of the second axis are located; and
a pair of side margins covering the pair of side surfaces, in which
at least at a part of boundaries between the laminate and the pair of side margins, an Si concentration discontinuously increases from the laminate to the pair of side margins.
<2> The multilayer ceramic electronic component as described in <1>, in which
the laminate includes
   a capacitance formation portion including the plurality of internal electrodes, and a plurality of inter-electrode ceramic layers of the plurality of ceramic layers, one of the plurality of inter-electrode ceramic layers being located between each pair of adjacent internal electrodes of the plurality of internal electrodes, and
   a pair of covers including outermost ceramic layers of the plurality of ceramic layers, the pair of covers sandwiching the capacitance formation portion, and
at least at boundaries between the capacitance formation portion and the pair of side margins, the Si concentration discontinuously increases from the capacitance formation portion to the pair of side margins.

<3> The multilayer ceramic electronic component as described in <2>, in which at the boundaries between the capacitance formation portion and the pair of side margins, the Si concentration discontinuously increases from the capacitance formation portion to the pair of side margins, and at boundaries between the capacitance formation portion and the pair of covers, the Si concentration discontinuously increases from the capacitance formation portion to the pair of covers.
<4> The multilayer ceramic electronic component as described in <1>, in which
the laminate includes
   a capacitance formation portion including the plurality of internal electrodes, and a plurality of inter-electrode ceramic layers of the plurality of ceramic layers, one of the plurality of inter-electrode ceramic layers being located between each pair of adjacent internal electrodes of the plurality of internal electrodes, and
   a pair of covers including outermost ceramic layers of the plurality of ceramic layers, the pair of covers sandwiching the capacitance formation portion, and
at least at boundaries between the pair of covers and the pair of side margins, the Si concentration discontinuously increases from the pair of covers to the pair of side margins.
<5> The multilayer ceramic electronic component as described in <4>, in which
only at the boundaries between the pair of covers and the pair of side margins, the Si concentration discontinuously increases from the pair of covers to the pair of side margins.
<6> A multilayer ceramic electronic component, including:
a laminate including a plurality of ceramic layers laminated in a direction of a first axis, a plurality of internal electrodes one of which is located between each pair of adjacent ceramic layers of the plurality of ceramic layers, and a pair of side surfaces that are perpendicular to a second axis orthogonal to the first axis and at which ends of the plurality of internal electrodes in a direction of the second axis are located, in which
the laminate includes
   a capacitance formation portion including the plurality of internal electrodes, and a plurality of inter-electrode ceramic layers of the plurality of ceramic layers, one of the plurality of inter-electrode ceramic layers being located between each pair of adjacent internal electrodes of the plurality of internal electrodes, and
   a pair of covers including outermost ceramic layers of the plurality of ceramic layers, the pair of covers sandwiching the capacitance formation portion, and
   at boundaries between the capacitance formation portion and the pair of covers, an Si concentration discontinuously increases from the capacitance formation portion to the pair of covers.
<7> The multilayer ceramic electronic component as described in <6>, in which
the multilayer ceramic electronic component includes
   a pair of side margins covering the pair of side surfaces, and
the Si concentration in the pair of covers and the Si concentration in the pair of side margins are equal.
<8> The multilayer ceramic electronic component as described in <6>, in which
the multilayer ceramic electronic component includes
   a pair of side margins covering the pair of side surfaces, and
at boundaries between the pair of covers and the pair of side margins, the Si concentration discontinuously increases from the pair of side margins to the pair of covers.
<9> The multilayer ceramic electronic component as described in <6>, in which
the multilayer ceramic electronic component includes
   a pair of side margins covering the pair of side surfaces, and
at boundaries between the pair of covers and the pair of side margins, the Si concentration discontinuously increases from the pair of covers to the pair of side margins.
<10> The multilayer ceramic electronic component as described in any one of <1> to <9>, in which
dimensions, in the direction of the second axis, of oxidized regions formed at the ends of the plurality of internal electrodes are 1 μm or less on average.
<11> The multilayer ceramic electronic component as described in any one of <1> to <10>, in which
the pair of side margins include
   a polycrystalline substance of a ceramic material as a main component, and
   a plurality of glass particles that are dispersed in the polycrystalline substance, a total volume ratio of the glass particles to the polycrystalline substance being 1% or more and 20% or less,
a median diameter of the plurality of glass particles is 0.20 μm or more and 0.80 μm or less, and is 90% or more of a median diameter of a plurality of crystal particles forming the polycrystalline substance, and
in cross sections of the pair of side margins, an average number of the glass particles observed among a plurality of 1 μm² regions that are arranged in a lattice form is 0.5 or more and 2 or less.
<12> The multilayer ceramic electronic component as described in any one of <1> to <11>, in which
the pair of side margins include a polycrystalline substance having a perovskite structure containing barium at A site and titanium at B site, and
an atomic ratio of Si to titanium at B site is 9 at % or less in the pair of side margins.

What is claimed is:

1. A multilayer ceramic electronic component, comprising:
a laminate including a plurality of ceramic layers laminated in a direction of a first axis, a plurality of internal electrodes one of which is located between each pair of adjacent ceramic layers of the plurality of ceramic layers, and a pair of side surfaces that are perpendicular to a second axis orthogonal to the first axis and at which ends of the plurality of internal electrodes in a direction of the second axis are located; and
a pair of side margins covering the pair of side surfaces, wherein
at least at a part of boundaries between the laminate and the pair of side margins, an Si concentration discontinuously increases from the laminate to the pair of side margins.

2. The multilayer ceramic electronic component as claimed in claim 1, wherein
the laminate includes
a capacitance formation portion including the plurality of internal electrodes, and a plurality of inter-electrode ceramic layers of the plurality of ceramic layers, one of the plurality of inter-electrode ceramic layers being located between each pair of adjacent internal electrodes of the plurality of internal electrodes, and
a pair of covers including outermost ceramic layers of the plurality of ceramic layers, the pair of covers sandwiching the capacitance formation portion, and
at least at boundaries between the capacitance formation portion and the pair of side margins, the Si concentration discontinuously increases from the capacitance formation portion to the pair of side margins.

3. The multilayer ceramic electronic component as claimed in claim 2, wherein
at the boundaries between the capacitance formation portion and the pair of side margins, the Si concentration discontinuously increases from the capacitance formation portion to the pair of side margins, and
at boundaries between the capacitance formation portion and the pair of covers, the Si concentration discontinuously increases from the capacitance formation portion to the pair of covers.

4. The multilayer ceramic electronic component as claimed in claim 1, wherein
the laminate includes
a capacitance formation portion including the plurality of internal electrodes, and a plurality of inter-electrode ceramic layers of the plurality of ceramic layers, one of the plurality of inter-electrode ceramic layers being located between each pair of adjacent internal electrodes of the plurality of internal electrodes, and
a pair of covers including outermost ceramic layers of the plurality of ceramic layers, the pair of covers sandwiching the capacitance formation portion, and
at least at boundaries between the pair of covers and the pair of side margins, the Si concentration discontinuously increases from the pair of covers to the pair of side margins.

5. The multilayer ceramic electronic component as claimed in claim 4, wherein
only at the boundaries between the pair of covers and the pair of side margins, the Si concentration discontinuously increases from the pair of covers to the pair of side margins.

6. A multilayer ceramic electronic component, comprising:
a laminate including a plurality of ceramic layers laminated in a direction of a first axis, a plurality of internal electrodes one of which is located between each pair of adjacent ceramic layers of the plurality of ceramic layers, and a pair of side surfaces that are perpendicular to a second axis orthogonal to the first axis and at which ends of the plurality of internal electrodes in a direction of the second axis are located, wherein
the laminate includes
a capacitance formation portion including the plurality of internal electrodes, and a plurality of inter-electrode ceramic layers of the plurality of ceramic layers, one of the plurality of inter-electrode ceramic layers being located between each pair of adjacent internal electrodes of the plurality of internal electrodes, and
a pair of covers including outermost ceramic layers of the plurality of ceramic layers, the pair of covers sandwiching the capacitance formation portion, and
at boundaries between the capacitance formation portion and the pair of covers, an Si concentration discontinuously increases from the capacitance formation portion to the pair of covers.

7. The multilayer ceramic electronic component as claimed in claim 6, wherein
the multilayer ceramic electronic component includes
a pair of side margins covering the pair of side surfaces, and
the Si concentration in the pair of covers and the Si concentration in the pair of side margins are equal.

8. The multilayer ceramic electronic component as claimed in claim 6, wherein
the multilayer ceramic electronic component includes
a pair of side margins covering the pair of side surfaces, and
at boundaries between the pair of covers and the pair of side margins, the Si concentration discontinuously increases from the pair of side margins to the pair of covers.

9. The multilayer ceramic electronic component as claimed in claim 6, wherein
the multilayer ceramic electronic component includes
a pair of side margins covering the pair of side surfaces, and
at boundaries between the pair of covers and the pair of side margins, the Si concentration discontinuously increases from the pair of covers to the pair of side margins.

10. The multilayer ceramic electronic component as claimed in claim 1, wherein
dimensions, in the direction of the second axis, of oxidized regions formed at the ends of the plurality of internal electrodes are 1 μm or less on average.

11. The multilayer ceramic electronic component as claimed in claim 1, wherein
the pair of side margins include
a polycrystalline substance of a ceramic material as a main component, and
a plurality of glass particles that are dispersed in the polycrystalline substance, a total volume ratio of the glass particles to the polycrystalline substance being 1% or more and 20% or less,
a median diameter of the plurality of glass particles is 0.20 μm or more and 0.80 μm or less, and is 90% or more of a median diameter of a plurality of crystal particles forming the polycrystalline substance, and
in cross sections of the pair of side margins, an average number of the glass particles observed among a plurality of 1 μm² regions that are arranged in a lattice form is 0.5 or more and 2 or less.

12. The multilayer ceramic electronic component as claimed in claim 1, wherein
the pair of side margins include a polycrystalline substance having a perovskite structure containing barium at A site and titanium at B site, and
an atomic ratio of Si to titanium at B site is 9 at % or less in the pair of side margins.
